(19) United States
(12) Patent Application Publication
(10) Pub. No.: US 2009/0113856 A1
(43) Pub. Date: May 7, 2009

(54) High Efficiency Dust Separation System For Mobile Sweeper Vehicles

(76) Inventors: Andrew B. Cooper, New Market, AL (US); Edward B. Stell, New Market, AL (US); Anthony C. Libhart, Hunstville, AL (US)

Correspondence Address: WALLACE G. WALTER, 5726 CLARENCE AVE, ALEXANDRIA, VA, 22311-1008, US

(21) Appl. No.: 12/263,486

(22) Filed: Nov. 2, 2008

Related U.S. Application Data
(60) Provisional application No. 60/985,625, filed on Nov. 5, 2007.

(51) Int. Cl. B01D 50/00

(52) U.S. Cl. 55/283

(57) ABSTRACT

An improved regenerative flow sweeping system for road and pavement sweeper vehicles includes first and second filter compartments as part of the recirculation loop in which the debris-entrained air is conducted from the intake hood into an initial separation compartment where some of the debris is removed from the air flow with the remaining air flow directed alternatively through one or the other of the first and second filter compartments for a selected period of time during which time finer particulates accumulate on the surface of the filter media. Thereafter, the air flow is redirected to the other filter compartment while pneumatic valves in the first filter compartment are selectively actuated to direct one or more pulses of compressed air into the filter media of the first filter compartment to remove accumulated particles on the filter media and effective “reverse flush” or purge the filter media. The first and second filter compartments are alternately place in and out of the air flow to filter particulates therefrom with the filter compartment that is taken out of the air flow subjected to the “reverse flush” to remove accumulate particulates therefrom.

### CROSS-REFERENCE TO RELATED APPLICATION

This application claims the benefit of U.S. Provisional Patent Application 60/985,625 filed Nov. 5, 2007 in common assignment herewith.

### BACKGROUND OF THE INVENTION

Various types of vehicles have been developed to sweep or vacuum debris from pavements, roadways, and streets. In general, these vehicles can be classified as mechanical broom sweepers, air sweepers, and combinational variants thereof.

Mechanical broom sweepers use a motor-driven broom or brooms to mechanically sweep paper, plastic, litter, trash, vegetation (leaves, twigs, grass clippings, etc.), asphalt and concrete debris, and larger sand or gravel particles toward a conveyor for transport into a debris collection hopper.

Regenerative air sweepers use a motor-driven fan to create a high-velocity recirculating air flow to aspirate dust, particulates, and other debris from the pavement or street surface. Optionally, a gutter broom is often mounted adjacent one or both lateral sides of the intake hood to brush debris into the path of the intake hood, and a powered brush roll can be mounted with or contained within the intake hood to assist in dislodging particulates from the swept surface for entrainment into the air flow.

In a typical regenerative system, a motor-driven fan develops a high-volume, high-velocity recirculating air-flow through a pickup or intake hood that is mounted closely adjacent the pavement surface. As the intake hood is moved along the pavement surface, debris is aspirated into the air flow and carried by ducting into and through a debris-collecting hopper or container. As the debris-laden air enters the debris-collecting hopper, the velocity of the air flow is reduced sufficiently so that many particulates drop out the air stream with various types of baffles, screens, grates, panels, etc. causing additional particulates to drop out of the air flow and collect in the hopper.

In a variant of the regenerative air flow systems, a portion of the pressurized air from the fan is vented or bled-off to the ambient atmosphere to create a situation in which make-up air enters into the intake hood about the periphery thereof to minimize or at least reduce the probability of fugitive dust and particulates escaping from beneath the intake hood into the surrounding atmosphere.

In the air flow systems of the type described, the separation of the air-entrained particles takes place within the hopper. In general, the velocity of the air flow is reduced in the hopper and the air is constrained to flow though screens and around baffles to cause a percentage of the entrained particles to “drop-out” of the air flow and to be collected in the debris hopper. It is the nature of these types of systems that only a percentage of the entrained material is removed from the air flow with some material remaining in the air flow as it is cycled and re-cycled through the fan and through the intake hood. The particles that remain entrained in the circulating air-flow are typically the extra-fine, low-density particles.

An effort has been made to increase the removal efficiency of extra-fine particles by filtration. For example, U.S. Pat. No. 6,161,250 to Young et al. discloses an arrangement by which a portion of the debris-entrained air flow is directed to a debris separation system that includes cyclone-type separators and cartridge filters to remove particles. While filtrations systems are known, the air flow rates and the particle loads often cause the particulates to accumulate on the filter media to effectively clog the filters with the particles being filtered. While a filter or filter array can be reverse flushed or purged with compressed air, overall efficiency of such systems is not considered optimal.

### SUMMARY

An improved regenerative flow sweeping system for road and pavement sweeper vehicles includes first and second filter compartments as part of the recirculation loop in which the debris-entrained air is conducted from the intake hood into an initial separation compartment where some of the debris is removed from the air flow with the remaining air flow is directed alternatively through one or the other of the first and second filter compartments for a selected period of time during which time finer particulates accumulate on the surface of the filter media. Thereafter, the air flow is redirected to the other filter compartment while pneumatic valves in the first filter compartment are selectively actuated to direct one or more pulses of compressed air into the filter media of the first filter compartment to remove accumulated particles on the filter media and effectively “reverse flush” or purge the filter media. The first and second filter compartments are alternately place in and out of the air flow to filter particulates therefrom with the filter compartment that is taken out of the air flow subjected to the “reverse flush” to remove accumulated particulates therefrom.

### BRIEF DESCRIPTION OF THE DRAWING

FIGS. 1 and 2 are left and right side elevation views of a sweeper vehicle in accordance with the present invention;

FIG. 3 is a top view of the sweeper shown in FIGS. 1 and 2;

FIG. 4 is a top view of an intake hood and gutter broom configuration;

FIG. 4a is a top view of a flow-control manifold, in partial cross-section, showing an internal adjustable vane;

FIG. 5 is a top view of the intake hood of FIG. 4;

FIG. 6 is a rear elevational view of the intake hood of FIG. 5;

FIG. 7 is a side elevational view of the intake hood of FIG. 6 with a side panel removed to reveal an interior compartment;

FIG. 8 is a bottom view of the intake hood of FIG. 6;

FIG. 9 is a view from the rear portion of a debris separation/filtration system, in partial cross-section, taken along line 9-9 of FIG. 3 showing an interior portion thereof;

FIG. 10 is a further view from the rear portion of the system shown in FIG. 9 with selected portions thereof removed for reasons of clarity;

FIG. 11 is a side view, in partial cross-section, of the system shown in FIG. 9 with selected portions thereof removed for reasons of clarity;

FIG. 12 is a view, in partial cross-section, from the forward portion of the system shown in FIG. 9 with selected portions thereof removed for reasons of clarity;

FIGS. 13 and 14 are illustrative examples or representations, respectively, of a filter mounting plate and flow diverter valve in a first position and the flow diverter valve in a second position;

FIGS. 15 and 15b are detailed views of a flow control panels in a first and a second position;

FIG. 15c is a plan view of the filter plate showing the top of each filter;

FIG. 15d is an example process flow diagram for implementing filter purging;

FIG. 16 is plan view of a first filtered air valving arrangement;

FIG. 17 is plan view of a second filtered air valving arrangement;

FIG. 18 is a schematic diagram illustrating the process flow in a first mode;

FIG. 19 is schematic diagram illustrating the process flow in a second mode;

FIG. 20 presents a variation of the embodiment of FIGS. 16 and 17;

FIGS. 21a and 21b are example control diagrams for effecting control of the structures shown in FIGS. 1-20; and

FIG. 22 is an isometric view of an exemplary purge or reverse flush valve.

### DESCRIPTION OF THE PREFERRED EMBODIMENTS

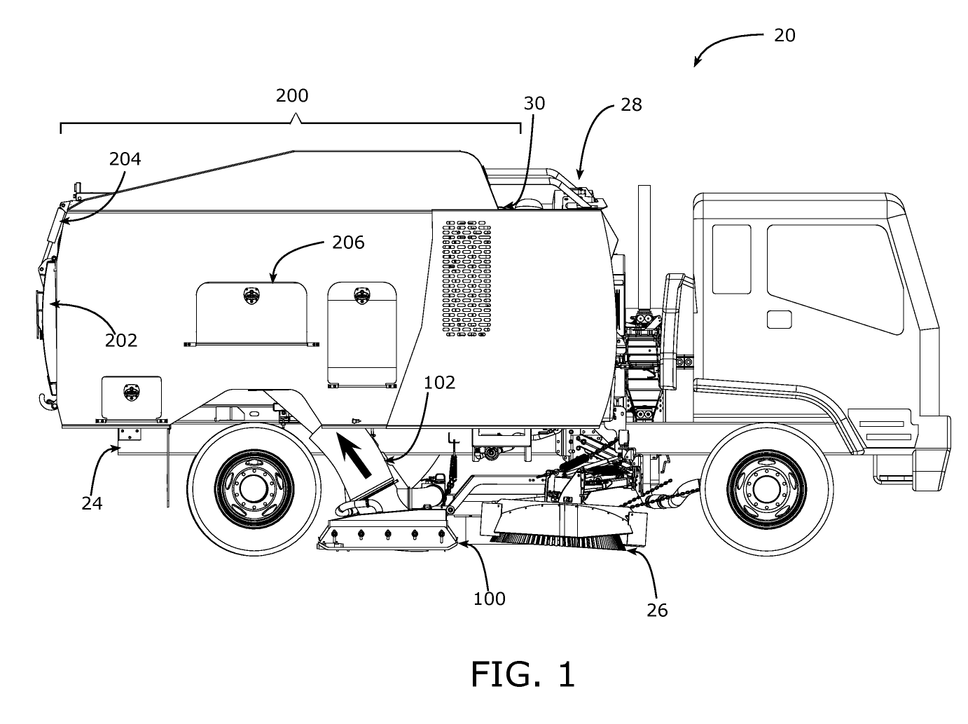

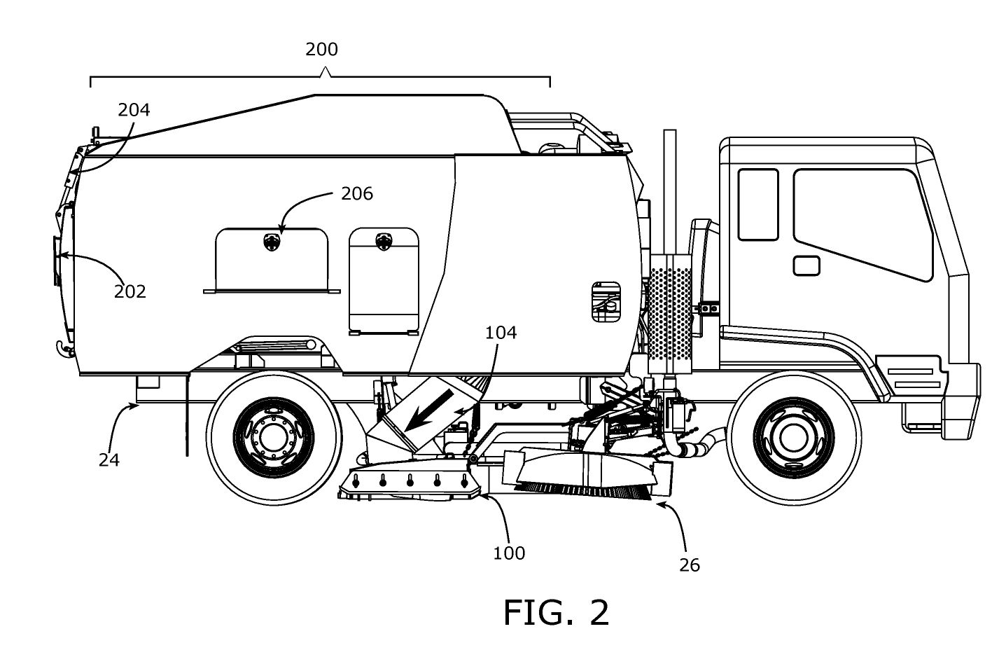

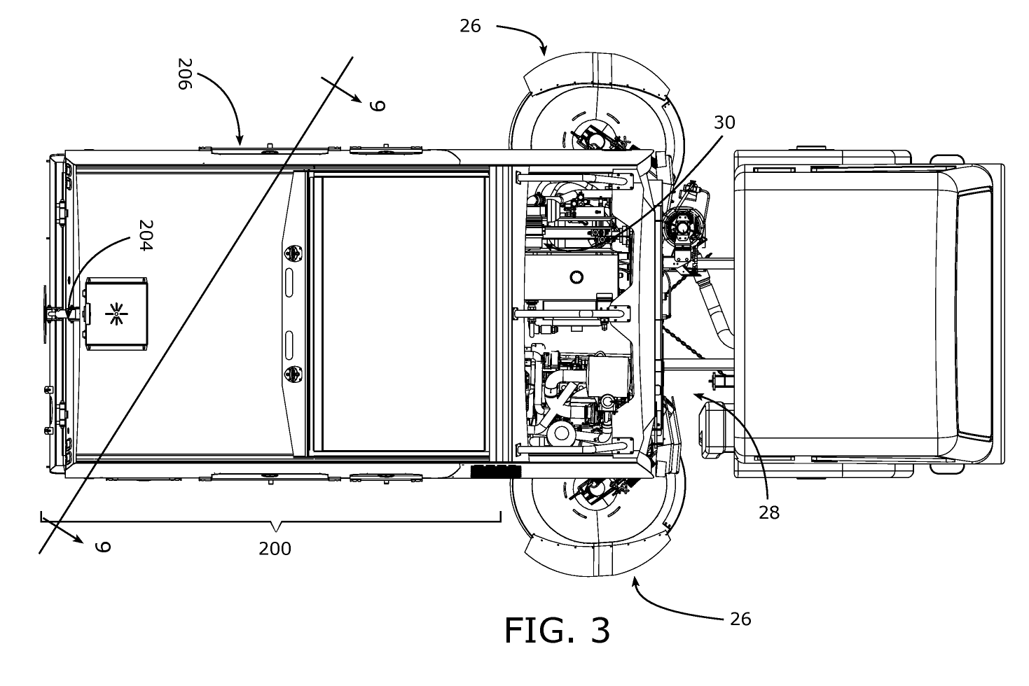

An exemplary pavement/street sweeper with a dust/particulate separation system in accordance with the preferred embodiment is shown in left and right side views in FIGS. 1 and 2 and generally designated by the reference character 20; the particular sweeper configuration shown is representative of sweepers manufactured by Schwarze Industries, Inc. of Huntsville, Ala. 35811 under the DXR designation. As shown in FIGS. 1 and 2, the truck-mounted sweeper system 20, which can be mounted on a commercial truck chassis, includes a pickup head or debris-intake hood 100 carried beneath the truck frame 24, an optional gutter broom 26 that is mounted forwardly of the debris-intake hood 100 on one or both sides thereof (as shown in the top view of FIG. 3), and a power unit 28 that includes (not specifically shown) a high-volume, high-velocity radial flow fan 30, an internal combustion engine for driving the fan 30, and associated hydraulic pump(s), air compressor(s), and various accessory and related equipment as is known in the art. As is known in this art, a bleed-off valve or vent (not shown) vents a fraction of the air flow from the fan 30 to the atmosphere to create a situation in which “makeup” air enters the intake hood 100 about the periphery thereof to reduce or at least minimize the probability of fugitive air flows therefrom. The radial flow fan 30 may take the form of the fan disclosed in U.S. patent application Ser. No. 09/528,168 filed Mar. 17, 2000 (now abandoned), the disclosure of which is incorporated herein by reference.

A debris separation/filtration system 200 is mounted rearwardly of the power unit 28 and functions as part of the air-flow recirculation loop to receive and accumulate debris that is aspirated or swept from the roadway surface. The debris separation/filtration system 200 includes a rear door 202 that is opened and closed by a hydraulic cylinder 204 as well as various inspection and/or access doors, generally indicated at 206.

As shown in FIG. 1, debris-laden air moves from the intake hood 100 through an intake duct 102 into the debris separation/filtration system 200 where particulates, dust, debris, etc. are separated. As explained in more detail below, the air moves into and through a first compartment where larger particles are separated from the air flow and then through one or the other of two filter compartments where the smaller particles are filtered from the air flow. The filtered air is thereafter passed into and through the fan 30 and then through ducting 104 (FIG. 2) into the intake hood 100 to complete the air-flow recirculation loop.

The intake hood 100 extends laterally substantially across the side-to-side width of the truck chassis from a driver side to the non-driver side of the vehicle. The intake hood 100 is typically suspended below the truck chassis 24 by links, bars, or chains (not specifically shown), or a combination thereof, so that the intake hood 100 can ride on or above the surface to be sweep as the sweeper vehicle 20 moves forward.

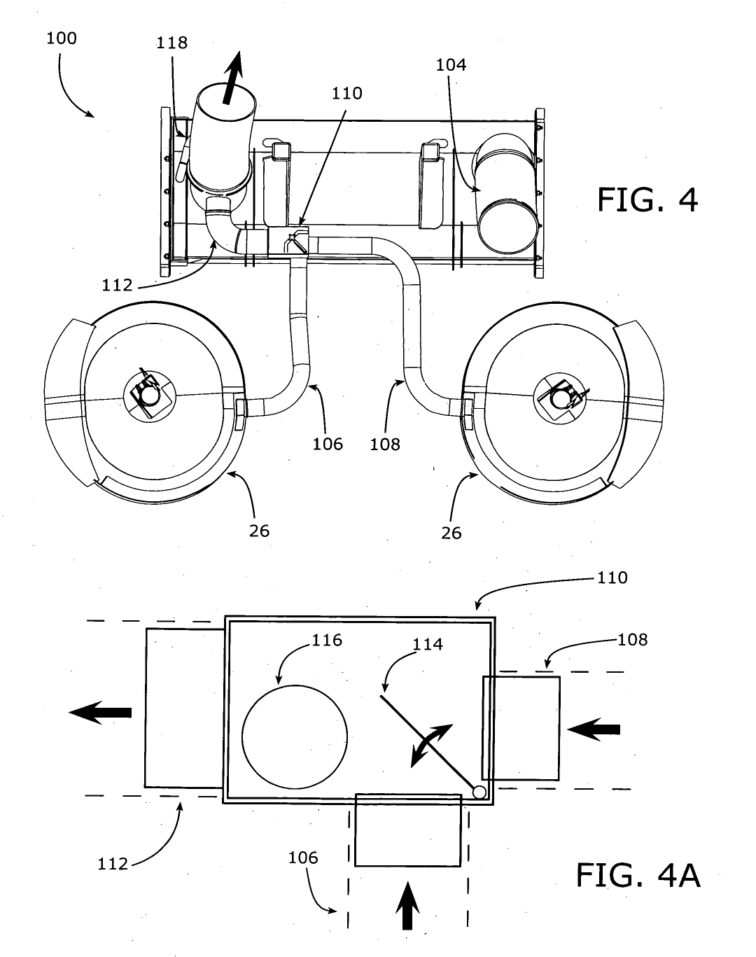

As shown in FIG. 4, the gutter brooms 26 are enclosed by appropriate shrouds to control dust with conduits 106 and 108 (which can be fabricated from an elastomeric material or a resilient shape-sustaining semi-rigid plastic) connected to a flow-control selector module or flow-control manifold 110 that, in turn, connects via a conduit 112 into the intake duct 102. Thus, at least some of the dust/debris that is made airborne by the rotary motion of the gutter brooms 26 can be contained within their respective shrouds and transferred to and into the intake duct 102 for removal in the separation/filtration system 200.

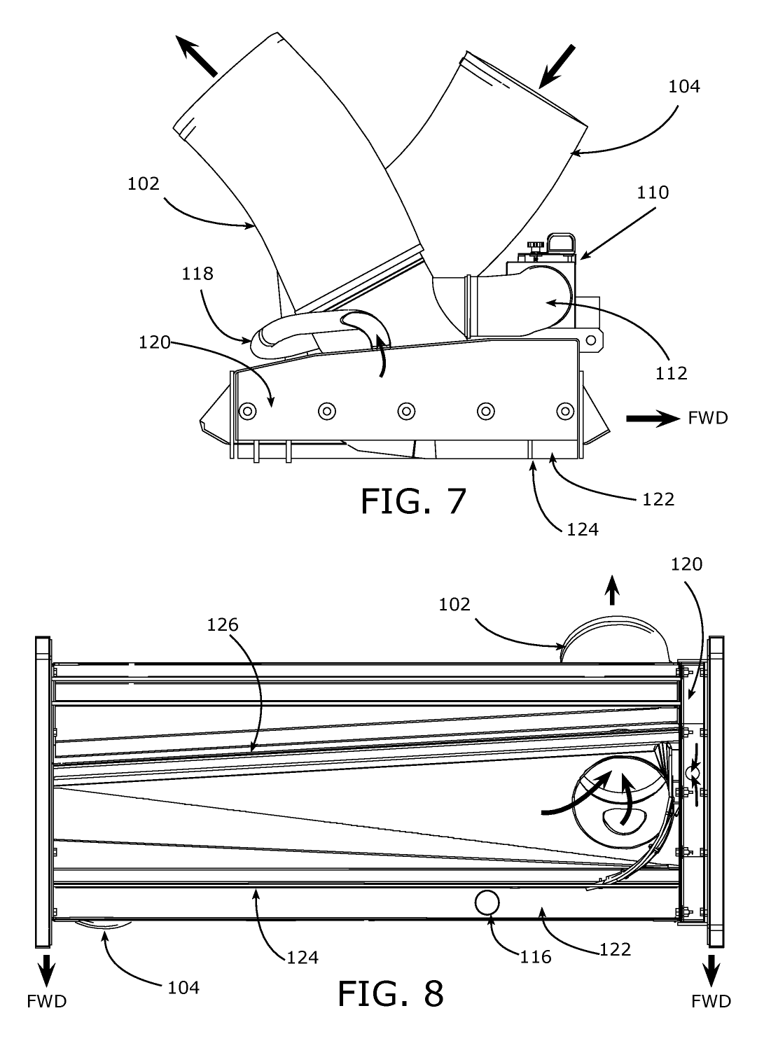

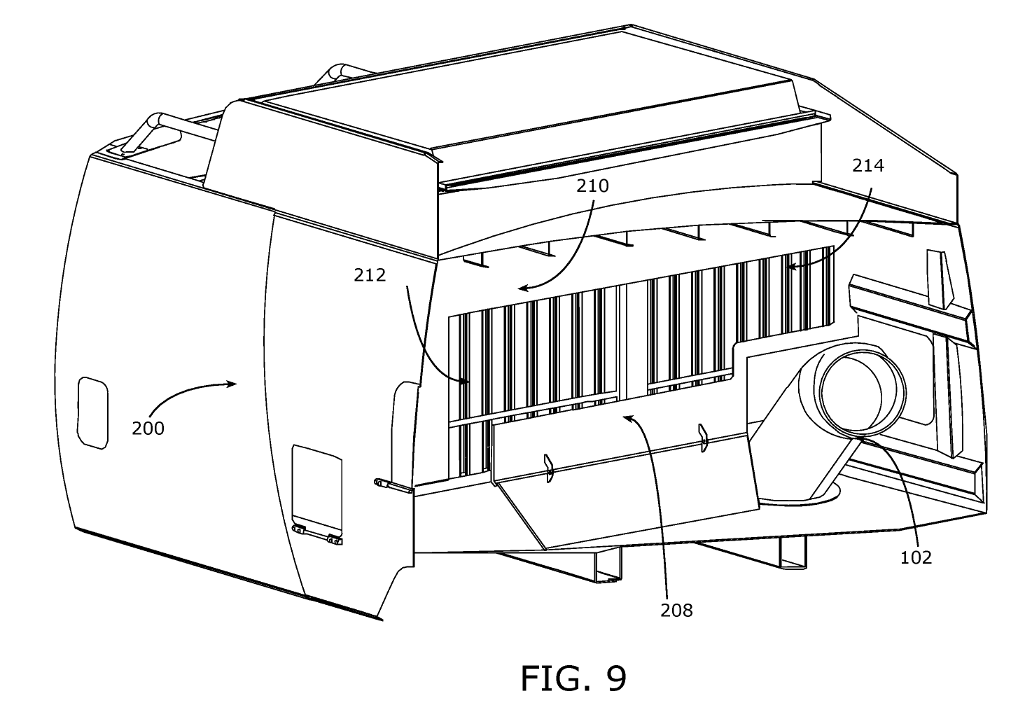

FIG. 4a is a plan view, in partial cross-section, of the flow-control manifold 110 of FIG. 4 and shows an internal axle-mounted vane 114 that can be manually rotated counterclockwise to the left right by the machine operator to substantially block flow from the conduit 106 so that flow from the conduit 108 is preferentially moved into the intake duct 102. In a similar manner, the vane 112 can be adjusted to substantially block flow from the conduit 108 so that flow from the conduit 106 is preferentially moved into the intake duct 102. Thus, when the gutter broom 26 on the left in FIG. 4 is sweeping against a curbstone, the vane 114 is positioned to substantially block flow from the conduit 108 to favor air flow from the left gutter broom 26 through conduit 106 into the intake duct 102, and, conversely, when the gutter broom 26 on the right in FIG. 4 is sweeping against a curbstone, the vane 114 is positioned to substantially block flow from the conduit 106 to favor air flow from the right side gutter broom 26 through conduit 108 into the intake duct 102. Additionally, the flow-control manifold 110 includes an opening 116 that extends through the top surface or ‘deck’ of the intake hood 100 through to a forward auxiliary vacuum plenum or compartment, described below in relationship to FIGS. 7 and 8.

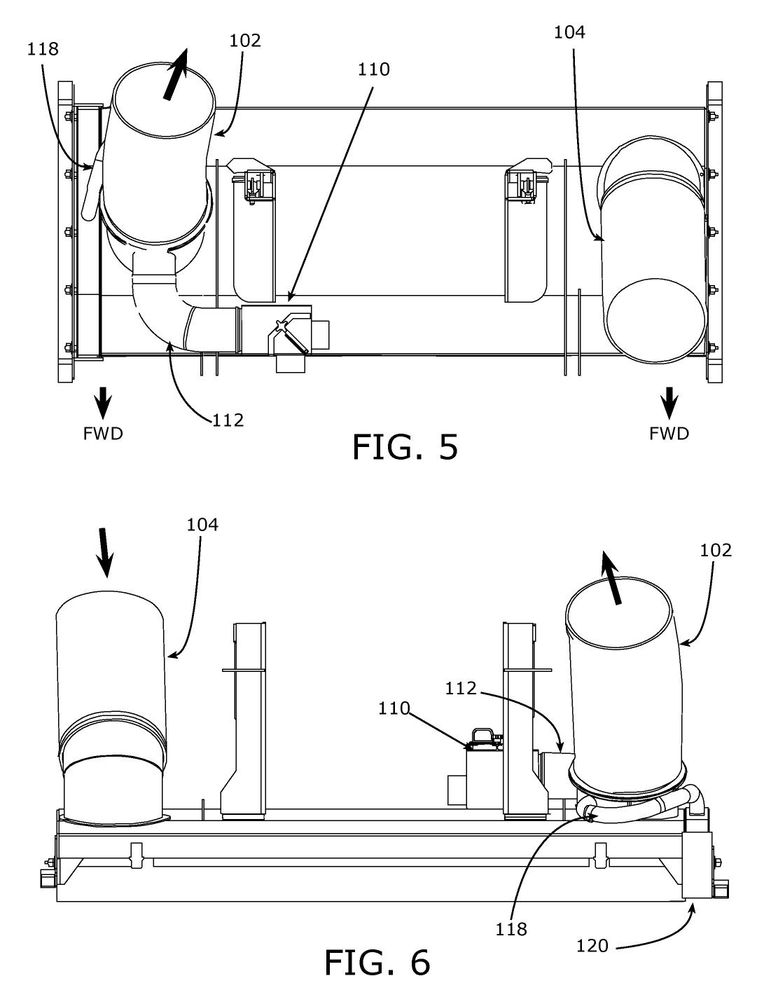

As shown on the left in the representative view of the intake hood 100 in FIG. 5 and on the right in FIG. 6, an auxiliary inlet conduit 118 connects the intake duct 102 to an auxiliary side plenum 120 in the intake hood 100. The side plenum 120, which is shown in cross-section in FIG. 7 and in the bottom-side view of FIG. 8, aspirates dust/particulates that enter therein into the intake duct 102 via the auxiliary inlet conduit 118.

As shown in FIGS. 7 and 8, a forward, laterally extending auxiliary vacuum plenum 122 is defined between the forward face of the intake hood 100 and a partition 124 with the auxiliary vacuum plenum 122 communicating via the opening 116 (FIG. 4a) in the flow-control manifold 110 and a corresponding opening in the deck of intake hood 100 with the conduit 112 and the intake duct 102.

Filtered air enters the intake hood 100 via the filtered-air conduit 104 and is forced through a narrow-width slot 126 to create an “air blade” or “air knife” that is effective to energized particulates on the pavement or roadway surface (including particulates within cracks and fissures) and aspirate them into the air flow beneath the intake hood 100 and then through the intake duct 102.

The intake hood 100 shown in FIGS. 1 and 2 does not include an associated powered broom; if desired an intake hood with an integrated broom can be provided, for example, as described in U.S. Pat. No. 5,884,359 issued Mar. 23, 1999 to A. Llbhart, the disclosure of which is incorporated herein by reference.

The organization of the sweeper unit 20 is configured so that air flow through the intake hood 100 is from the driver side of the vehicle to the non-driver side of the vehicle, as is conventional in the industry. If desired, the sweeper can be configured so that air flow through the intake hood 100 is from the non-driver side to the driver side as disclosed in U.S. patent application Ser. No. 11/407,293 filed Apr. 20, 2006, the disclosure of which is incorporated herein by reference.

FIG. 9 is a cross-sectional view through the rear portion of the debris separation/filtration system 200 showing a portion of a separation compartment 208 where the flow of debris-entrained air from the intake duct 102 enters the separation compartment 208 and undergoes a reduction in flow velocity causing some of the entrained debris/particulates to drop-out of the air flow. The separation compartment 208 includes various baffles, grates, screens, etc. (not shown) to cause additional particulates to drop out of the air flow. If desired, water can be sprayed in or adjacent to the outlet opening of intake duct 102 to cause the finer dust particles to clump or agglomerate together in the separation compartment 208.

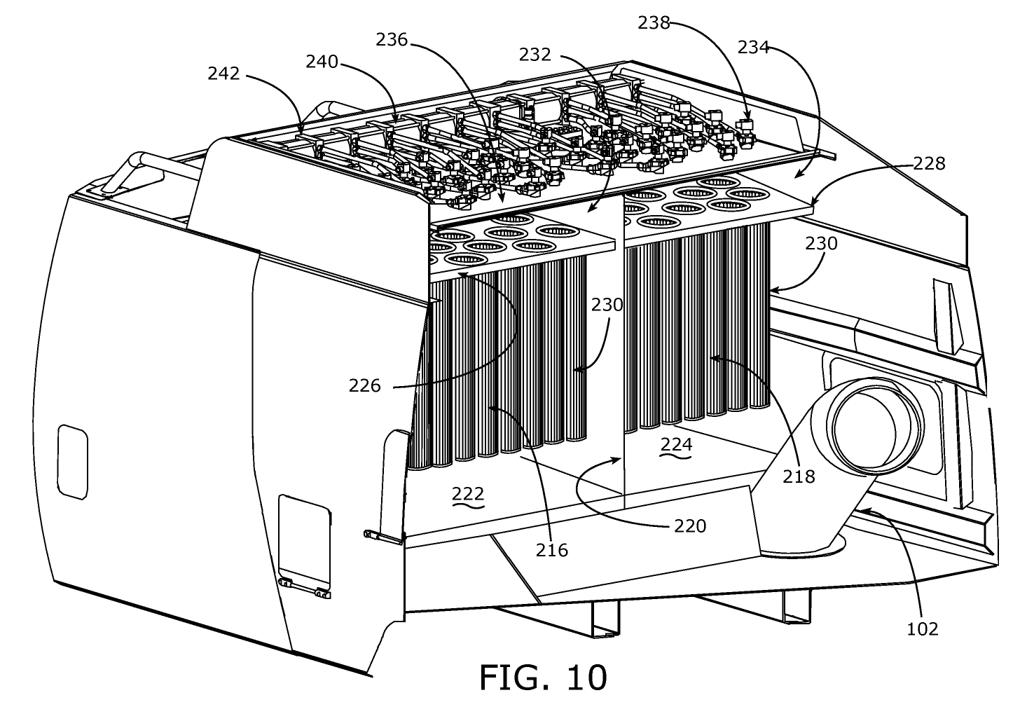

The forward end of the separation compartment 208 is defined by a partition 210 that includes a first baffle set 212 and a second baffle set 214 that constitute the entry openings into a first filter compartment 216 and the second filter compartment 218 (shown in FIG. 10). The baffle sets 212 and 214 are defined by spaced vertically aligned slats that assist in slowing heavier particulates in the air flow to cause those heavier particulates to drop out of the air flow. The slats that define the baffle sets 212 and 214 can be removed, for example, when sweeping leaves.

As shown in FIG. 10, a partition 220 separates both the first filter compartment 216 and the second filter compartment 218 with each compartment having respective bottom panels, 222 and 224, and respective filter mounting plates, 226 and 228. The various partitions and panels, along with the structure of the outer shell of the debris separation/filtration system 200 define two adjacent filter compartments 216 and 218 through which a substantial portion of the air flow can be alternatively directed for filtration.

As shown in FIG. 10, each filter mounting plate 226 and 228 carries a plurality of vertically aligned cartridge filters 230 with the interior of each cartridge filter opening into a filtered-air headspace 232 and 234 above each filter mounting plate 226 and 228.

In the preferred embodiment, each filter compartment, 216 and 218, is equipped with fifteen cartridge filters 230 with each filter having an overall length of about 36 to 44 inches with a diameter of between 6 and 8 inches with a sufficient number of pleats (i.e, about 60-90 in the case of the preferred embodiment) to provide adequate filter surface area. The filter media is preferably a spun bond polyester. Suitable filters are available from Schwarze Industries, Huntsville Ala. under part number 23068. While pleated media cartridge-type filters are preferred, other type of filter structures/arrangements are equally suitable.

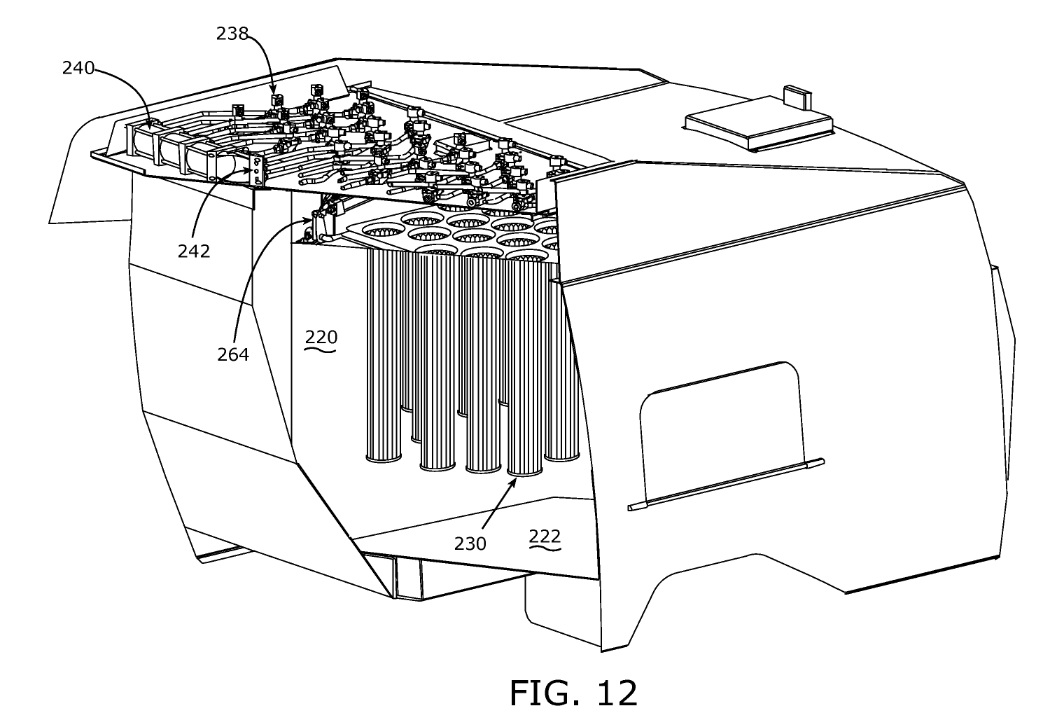

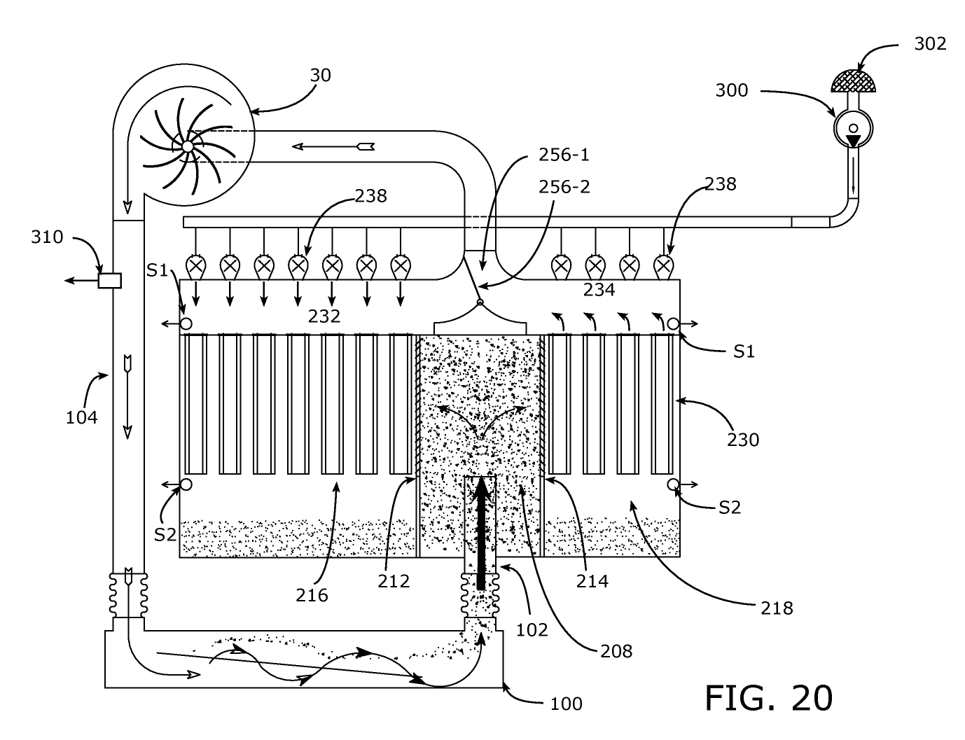

As shown in FIGS. 10, 11, and 12, a purge-valve mounting plate 236 is positioned above and spaced from the filter mounting plates 226 and 228 to define the upper extent of the filtered-air headspaces 232 and 234. The purge-valve mounting plate 236 has a plurality of “reverse flush” or purge valves 238 mounted thereon; each valve 238 is a selectively or controllably actuatable (i.e., by electrical solenoid) pneumatic valve designed to produce a directional jet or pulse of compressed air through an outlet. In the preferred embodiment, each purge valve 238 is mounted above a respective cartridge filter 230 with the outlet of the valve 238 directed downwardly toward the interior portion of the cartridge filter 230. A compressed air manifold 240 extends laterally across the purge-valve mounting plate 236 at the forward end thereof and includes sub-manifolds or distributors 242 that include threaded ports (not specifically shown) for connection to a respective purge valve 238 through an appropriate air line (unnumbered). The compressed air manifold 240 is connected to a source of compressed (such as a compressor driven by the truck engine or a compressor driven by the same motor in the power unit 28 that drives the fan 30). In the preferred embodiment, the compressed air supply is maintained at a pressure of about 120 PSI. As explained in more detail below, the purge valves 238 are preferably operated in a selected sequence in response to commands from a controller to introduce an appropriate “blast” or “puff” of compressed air into the respective cartridge filter 230 to reverse flush debris that has accumulated or loaded onto the face of the filter media and thus ‘clear’ the media for continued use. Suitable purge valves 238 include on/off valve/nozzle assemblies with an integrated 12 VDC solenoid actuator, such as 8353 series valves available from ASCO Valve, Inc., Florham Park N.J., a representative example of which is shown in FIG. 20.

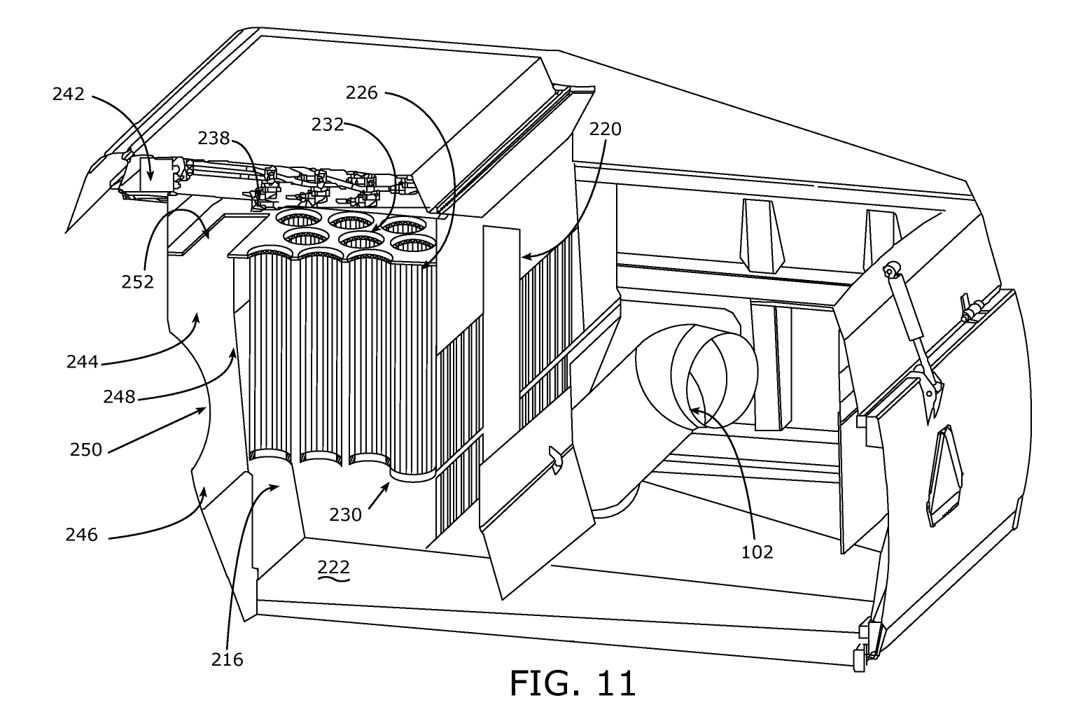

As shown in FIG. 11, a filtered-air plenum 244 is located forward of the filter compartments, 216 and 218, and is defined between panels or partitions 246 and 248. The partition 246 includes a circular opening 250 through which filtered air is passed to the inlet of the fan 30 (not shown).

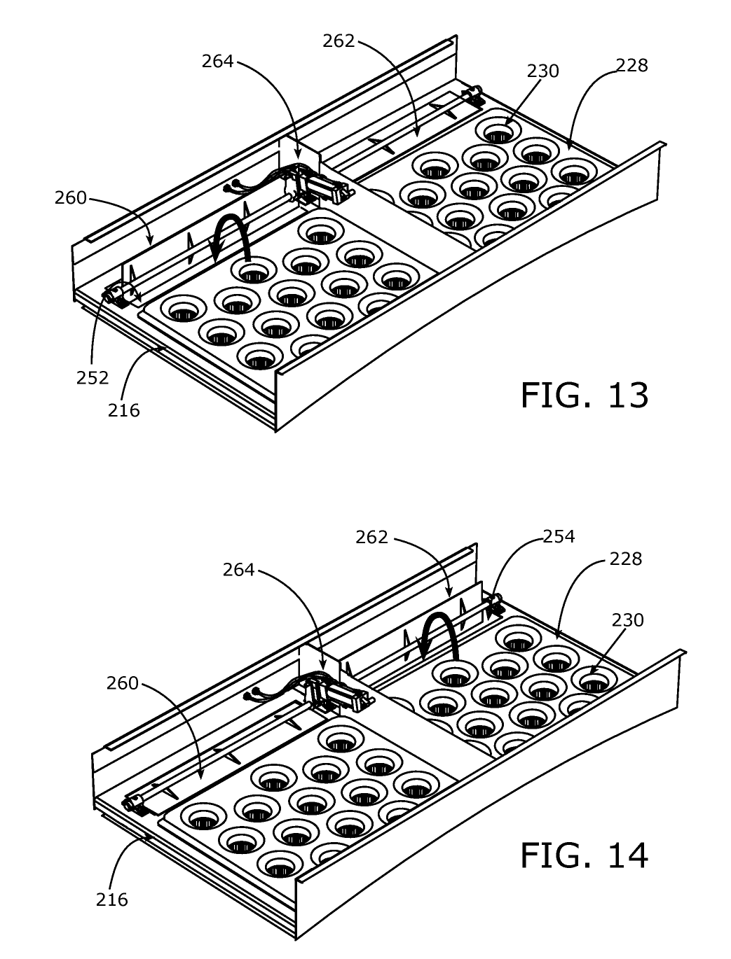

The forward portion of the filter mounting plate in each filter compartment 216 and 218 includes, in the preferred embodiment, a rectangular through opening through which filtered air from the filtered-air headspace passes into the filtered-air plenum 244. As shown FIGS. 13 and 14, the filter mounting-plate 226 includes a rectangular opening 252 at its forward end through which filtered air can pass from the filtered-air headspace 232 into the filtered-air plenum 244. In a similar manner, the filter mounting-plate 228 includes a rectangular opening 254 at its forward end through which filtered air can pass from the filtered-air headspace 234 into the filtered-air plenum 244. Filtered air in the plenum 233 is then conducted through the opening 250 (FIG. 11) into the fan 30.

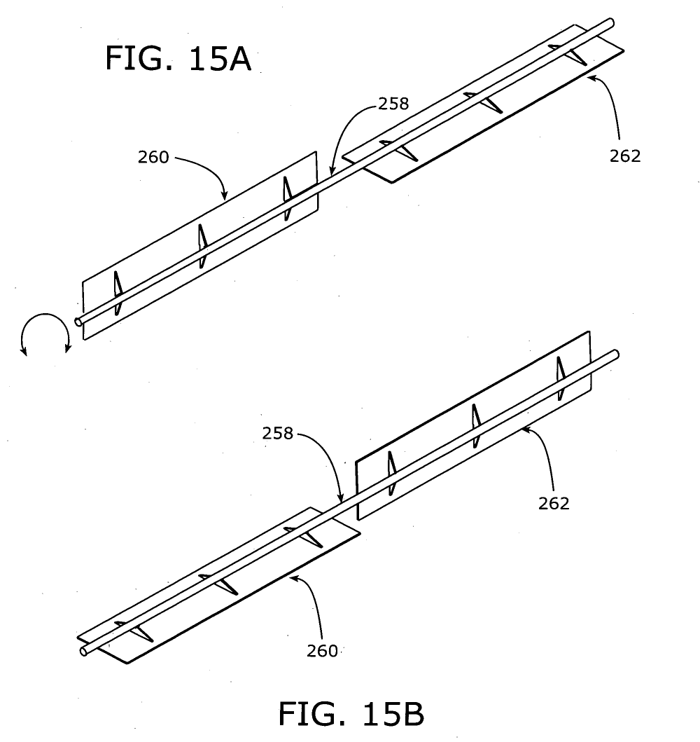

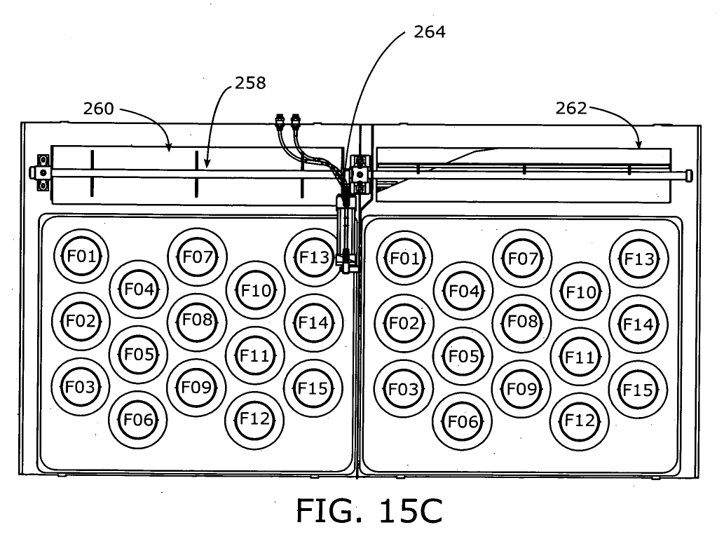

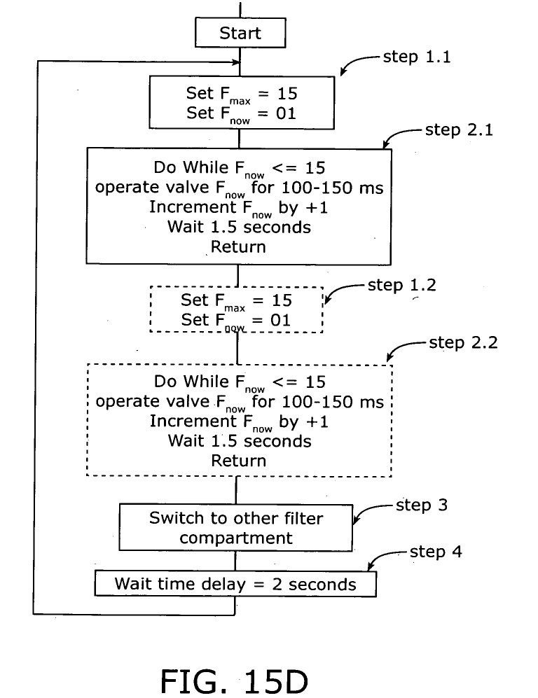

Air flow control from either the filtered-air headspace 232 into the filtered-air plenum 244 through the opening 252 or from the filtered-air headspace 234 into the filtered-air plenum 244 through the opening 254 is effected with a dual-panel flow diverter valve assembly, generally designed by the reference character 256. As shown in FIGS. 13 and 14 and in the detail of FIGS. 15a and 15b, the flow diverter valve 256 includes an appropriately journalled shaft 258, a first valve plate appropriately sized and positioned to substantially block flow through the opening 252 (FIG. 14) and another valve plate 262 appropriately sized and positioned to substantially block flow through the opening 254; the valve plates, 260 and 262, are oriented so that one or the other of the valve plates can block flow through its respective opening. A pneumatic actuator 264 (or an hydraulic or electrical functional equivalent thereof) and appropriate linkage is used to rotate the shaft 258 (FIG. 14) so that one of the valve plates substantially blocks flow through its opening or the other of the valve plates substantially blocks flow through its respective opening. In general, it is not necessary that the valve plates completely block or shut-off all the air flow therethrough; some small amount of air flow leakage can be tolerated and is expected, it is only necessary that a valve plate block enough flow to cause most of or a major portion of the air flow to be diverted to the other filter compartment.

In operation, a recirculating air flow loop is established with the air flow in the separation compartment 208 and flowing into both the first filter compartment 216 and the second filter compartment 218 through their respective first baffle set 212 and second baffle set 214. When the flow diverter valve 256 is controlled by its pneumatic actuator 264 to substantially block flow through the second filter compartment 218, the air flow will preferentially pass into the first filter compartment 216 and through the filter media of the various cartridge filters 230 with any dust, debris, particulates, etc. in the air flow separated therefrom by the filter media. Some of the separated material will fall to the bottom the filter compartment 216 while some of the material will remain on the filter media; with time, the material that remains on the filter media can accumulate to “face load” or “cake-on” the media. The filtered air that passes through the filter media enters the filtered-air headspace 232 above the filter mounting-plate 226 and passes through the opening 252 into the filtered-air plenum 244 and through the opening 250 therein into the fan 30 where the now-filtered air flows through the filtered-air conduit 104 into the intake hood 100 where the filtered air is directed against the pavement or roadway to remove and entrain dust, debris, particulates, etc. into the air flow for removal through the intake duct 102 and into the separation compartment 208 where the process cycle repeats.

With continued operation, the filter media will accumulate the finer dust, debris, particulates, etc. with the possibility of decreased performance.

After some period of time, the flow diverter valve 256 is controlled by its pneumatic actuator 264 to rotate shaft 258 and open flow through the second filter compartment 218 while substantially blocking flow through the first filter compartment 216, the air flow will now preferentially pass into the first second compartment 218 and through the filter media of the various cartridge filters 230 therein with any dust, debris, particulates, etc. in the air flow with separated therefrom by the filter media.

As can be appreciated, the first filter compartment 216 and the second filter compartment 218 are each alternately placed into or “switched” into the recirculating flow path to effect filtering of the air flow and each alternatively taken out of the flow path, i.e., each filter compartment is alternatively “on-line” or “off-line”.

Switching between the “on-line” filtration mode and the “off-line” purge mode can be accomplished using fix-length timing cycles in which switching is under clock control. For the structural and flow organization described above, alternating 45-second “on-line/off-line” cycles are generally adequate. During the 45-second “off-line” period, the air flow in the “off-line” filter compartment is substantially “stilled” by the blocking of its valve opening by its portion of the flow diverter valve to allow some of the entrained dust/particulates to “drop-out” of the air.

During the time period that a filter compartment is not in the flow path (i.e., it is effectively “off-line”), the purge valves 238 are operated to direct a burst or pulse of compressed air at an appropriate pressure (e.g., about 120 psi) into each cartridge filter 230 in the “off-line” filter compartment to effectively provide a “reverse flush” or “purge” air flow to dislodge or remove any dust, debris, particulates, etc. that has accumulated on the filter media. A filter compartment is taken “off-line” and its cartridge filters 230 is subjected to the “reverse flush” or purge operation at a frequency and duration sufficient to assure continued optimal function of the filter media.

Once the filter compartment is “off-line,” a filter purge sequence is initiated to a “reverse flush” or “purge” air flow to dislodge or remove any dust, debris, particulates, etc. that has accumulated on the filter media. In FIG. 15c, the various cartridge filters in the left side filter compartment 216 have been labelled F01 through F15 and the various filters in the right side filter compartment 218 also labelled F01 through F15; the flow diverter valve 256 is positioned to take the filter compartment 216 on the left “off-line” and thus become available for the “reverse flush” or “purge” air flow operation.

FIG. 15d presents an illustrative or example process diagram for controlling the various purge valves 238. As shown and after initial start-up, the variable Fₘₐₓ is set to 15 representing the fifteen filters (i.e., F01-F15) in the now “off-line” compartment and the variable F_{now} is set to 01 (step 1.1). Thereafter and at step 2.1, a DoWhile loop is entered by which the purge valve for the first filter F01 is operated to subject the filter to an air blast having a duration of about 150 milliseconds+/−50 milliseconds with the system then waiting some time period (i.e., 1.5 seconds). The air blast effects a “reverse flush” or purge each filter cartridge 230 to clear or remove fine particulates that can “cake on,” clog, block, or impede air flow through the filter media.

The F_{now} variable is incremented by one so that F_{now}=02 and the second filter F02 thereafter subject to an air blast. The step 2.1 loop is continued until all filters are subject to one air flush to complete a single cycle. The 100-150 ms air pulse duration and the 1.5 second wait time are representative only; the air pulse duration and the wait time can be longer or shorter depending upon the environment in which the machine is operated. While one full cycle of each filter compartment is preferred and as shown in dotted-line, the steps 1.1 and 2.1 can optionally be repeated as steps 1.2 and 2.2 to provide a second cycle; additional cycles are not excluded. Upon the completion of the purging cycle for the one filter compartment, the flow diverter valve is operated to switch to the other compartment and the process repeated. While the process of FIG. 15d shows the uses DoWhile loops, numerous other software functions, including the IF/Else function can be used.

As can be appreciated, this reverse flush or purge program can be modified depending upon actual conditions experienced during use; thus, more than one filter cartridge 230 can be purged at the same time and pulse durations, inter pulse spacings, and the total number of cycles can be changed. For example and a shown in the following table, a 6-row look-up table can be stored in memory with each row specifying two or three filters for which their purge valves are to be operated simultaneously, as follows:

F01 F07 F13
F04 F10
F02 F08 F14
F05 F11
F03 F09 F15
F06 F12

Using the table above, a first group of three filters in the first row would be purged followed by a subsequent group of two filters in the second row with this row-by-row sequence continuing until all filters are purged.

While a fixed-time “program” is preferred, control of the flow diverter valve 256 can be responsive to a sensor arrangement. For example, pressure sensors can be placed in each filter compartment on opposite sides of the filter media to measure the pressure on each side of the filter media and the pressure drop thereacross with the electrical output of each sensor provided to the controller so that the “on-line/off-line” changeover is responsive to the actual pressure differential experienced in each compartment.

The system described above can operate under the supervision of an appropriately programmed controller that can take the form of one or more stored-program controlled (i.e., firmware and/or software) microprocessors or microcomputers (as well as special-purpose processors, including RISC processors), application specific integrated circuits (ASIC), programmable logic arrays (PLA), discrete logic or analog circuits, with related non-volatile and volatile memory, and/or combinations thereof. In the preferred embodiment, a preferred commercially available 12 VDC “mobile” programmable controller is available from IFM Efector, Inc., Exton Pa. under the part designation CR0020 for use with the 12 VDC 8353 series ASCO valves (FIG. 20) used as the purge valves 238.

While firmware- or software-controlled microprocessors or microcomputers are preferred for the controller, the controller can also take the form a set of motor-driven rotary cams operating cam-driven switches to turn the various purge valves 238 on and off and to control the pneumatic actuator assembly 264 (or an electrical or hydraulic functional equivalent). In some applications, the flow control valve can be directly controlled by mechanical links or Bowden-type cables connected to an operator-controlled manual manipulator in the cabin of the truck.

While the “on-line/off-line” procedure described above is preferred and is contemplated as the primary sweeping mode for the vehicle, there are occasional circumstances in which both filter compartments should be kept on-line for a selected time period. For example, where the vehicle is to sweep heavier-than-usual particulates from the roadway or pavement, the pneumatic actuator 264 can be adjusted so that the panels 260 and 262 are aligned at an angle (i.e., 45°) relative to their respective filtered air openings 252 and 254 so that a higher volume of air can be moved through the filter compartments to the fan 30. Once this both-compartments-on-line mode is completed, the system can return to the above described “on-line/off-line” procedure during the filters in each compartment will be subject to a reverse air flow purge.

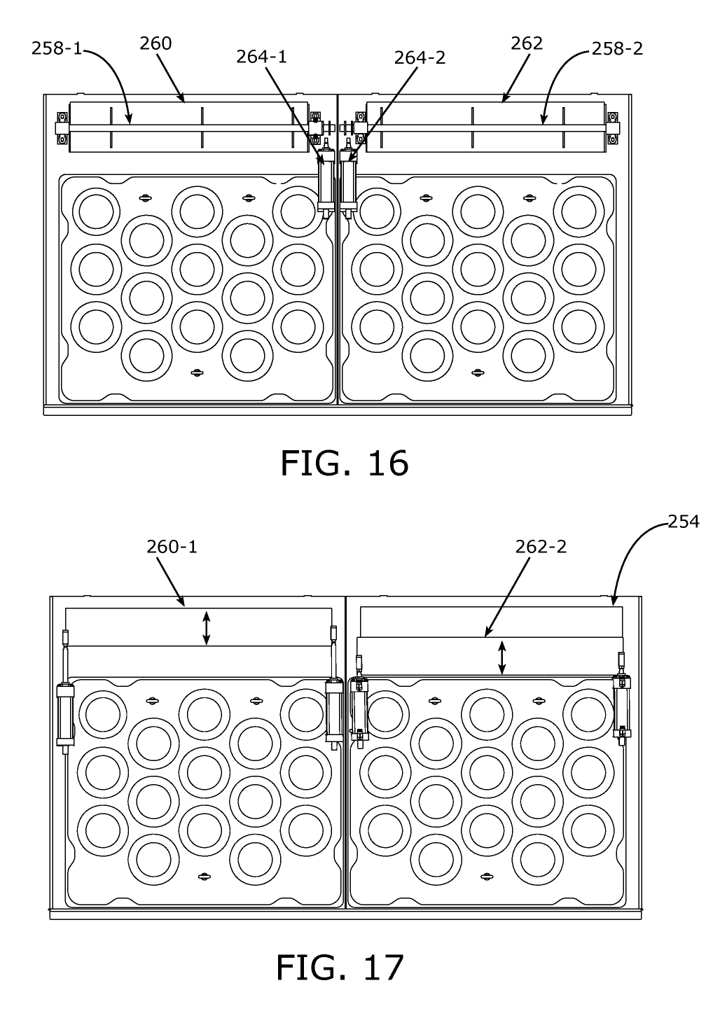

The flow diverter valve 256 described above uses one actuator assembly 264 to control the flow through both filter compartments 216 and 218 by rotating and counter-rotating a common shaft 258 connected to the valve plates, 260 and 262. As can be appreciated and as shown in FIG. 16, a separate shaft 258-1 and 258-2 can be connected to each valve plate 260 and 262 and independently operated by respective pneumatic cylinders 264-1 and 264-2. While the rotatable shaft arrangement is preferred, other valving arrangements are suitable, for example and as shown in FIG. 17, valve plates 260-1 and 260-2 are arranged to slide over and block their respective openings 252 and 254 under independent control of pneumatic cylinder pairs (unnumbered).

Independent control of the filtered air valving from each filter compartment allows both filter compartment to be in the flow path, for example, where the vehicle is to sweep heavier-than-usual particulates from the roadway or pavement. Additionally, both valves can be closed to take both filter compartments “off-line” so both filter compartments can be subject to the reverse air purge sequence to remove particulates from the filter media in both filter compartments compartment 216 and 218.

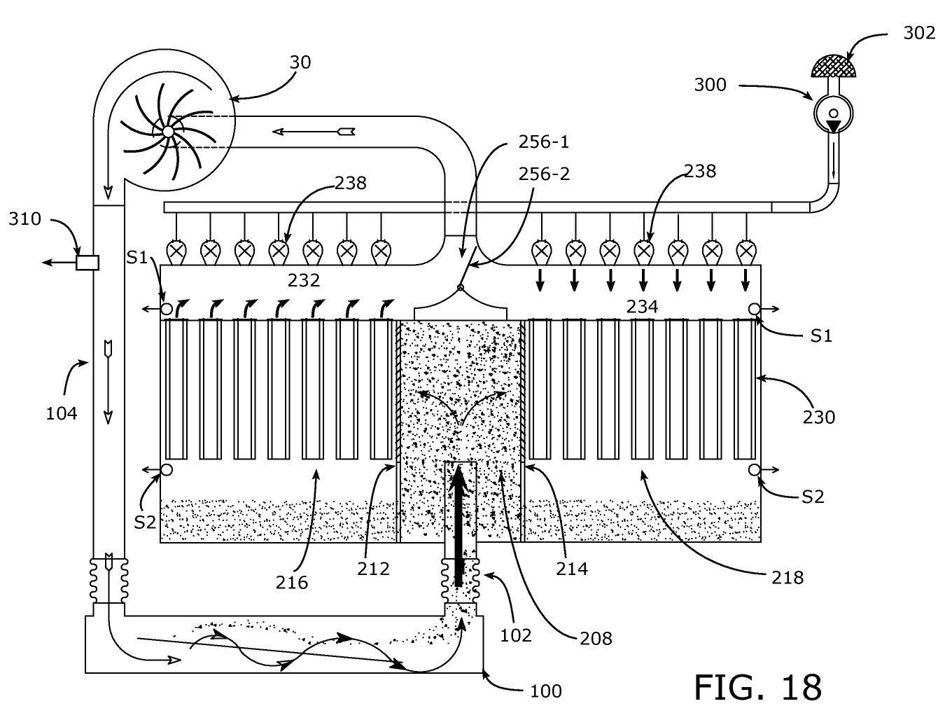

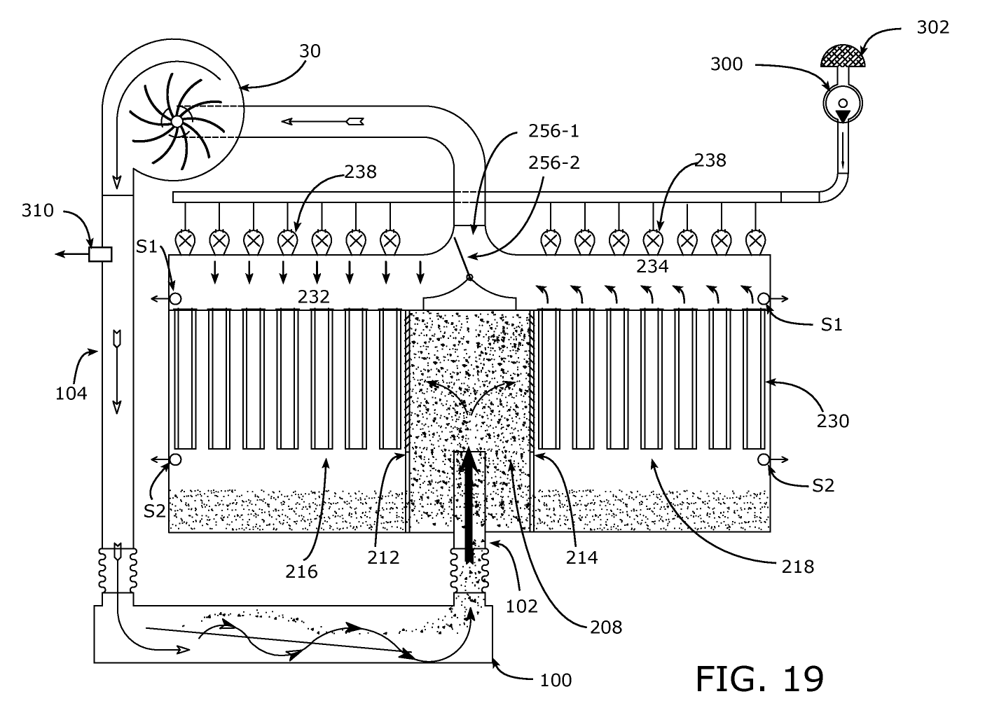

The recirculating air flow and its passage through one or the other of the filter compartments is visualized in schematic view in FIGS. 18 and 19. As shown, the dust/particulate separation compartment 208, first and second dust/debris separation filter compartments 216 and 218 that each have a respective headspace plenum, 232 and 234, a changeover or flow-diverter valve assembly 256-1, a fan assembly 30, the intake hood 100 described above, a plurality of filter elements 230 in each filter compartment 216 and 218, compressed air purge valves 238, and various connecting ducts.

Each dust/debris filter compartment 216/218 includes one or more filter elements 230, such as pleated-media cartridge-type filters, and one or more screens or baffles, 212/214, separating the dust/particulate separation compartment 208 from the dust/debris filter compartments 216/218 and through which the air flow passes to separate larger dust/debris/particulates. As the dust/particulates laden air passes through the baffles, 212/214, into the respective filter compartments, 216/218, the larger dust/debris/particulates fall to and collect on the bottom of the compartment 208. A compressed-air purge valve 238 is mounted above each cartridge filter 230 to “reverse flush” or purge each filter cartridge 230 to reverse the effects of face loading on the surface of the filter media, i.e., to clear or remove fine particulates that can “cake on,” clog, block, or impede air flow through the filter media.

In the system of FIGS. 18 and 19, the fan 30 increases the velocity of the filtered air flow and directs that filtered air outflow through the filtered air duct 104 into the intake hood 100. The high-velocity air is directed against the pavement or roadway as a narrow-width air blade that is effective to entrain dust, debris, and particulates under the intake hood into the air flow. The dust/particulate laden air then flows through intake duct 102 that empties or discharges into the volume that defines the separation compartment 208 where the velocity of the air flow diminishes with the larger particulates separating out of the now lower-velocity air flow and falling to the bottom of the separation compartment 208. If desired, water can be sprayed in or adjacent the outlet opening of inlet conduit to cause the finer dust particles to clump or agglomerate together in the separation compartment 208. The air in the separation compartment 208 then flows through baffles 213/214 filter compartments 216/218 with the baffles 213/214 effective to remove further particles from the air flow.

The flow director valve 256-1 is controllable to connect the headspace plenum 232 above the filter compartment 216 to the inlet of the fan 30 or connect the head space plenum 234 above the filter compartment 218 to the inlet of the fan 30. In this embodiment, the flow director valve 256-1 includes movable plate, flap, or flow control panel 256-2 that is movable between a first position in which the filtered air from the head space plenum 232 is connected to inlet of the fan 30 and a second position in which the head space plenum 234 is connected to inlet of the fan 30. In general, it is not necessary that the flow control panel completely block or shut-off all the air flow through the off-line compartment; some small amount of air flow leakage can be tolerated and is expected, it is only necessary that the flow control panel cause most of or a major portion of the air flow to be diverted to the on-line filter compartment.

In the configuration shown in FIG. 18, the flow control panel 256-2 of the flow diverter valve 256-1 is positioned to steer or guide the flow of filtered air from the head space plenum 232 into the inlet of the fan 30. In this configuration, air in the separation compartment 208 is passed through the baffle 212 into the filter compartment 216. The baffle 212 functions to separate a portion of the debris/dust/particulates from the air flow with the separated material falling to and collecting on the bottom of the separation compartment 208 and/or the filter compartment 216. The air flow then suffuses into and through the volume of the filter compartment 216 with the flow passing through the filter media of the various cartridge filters 230 to remove dust and particulates having sizes above the filter-size specification for the filter media. As shown by the rightwardly facing arrows above each cartridge filter 230 in FIG. 18, the filtered air exits each cartridge filter 230 into the headspace 232 above the cartridge filters 230 where the now filtered air moves through the flow diverter valve 256-1 and is steered by the flow control panel 256-2 into the intake ducting of the fan 30. The filtered air is pressurized by the fan 30 and directed by duct 104 into the intake head 100. A bleed-off valve 310 is provided in the air flow pathway at or between the outlet of the fan 30 to vent some fraction of the filtered air to the atmosphere; this bleed-off causes make-up air to be drawn into the underside of the intake hood 100 from the ambient area around the periphery of the intake hood 100 to reduce or at least minimize the escape of fugitive air flows and any particulates from the intake hood 100.

During the filtration process, some of the dust and particulates will fall downwardly to the bottom of the filter compartment 216 while some of the finer particulates will accumulate on or “cake on” the filter media. The rate at which the finer particulates will accumulate on the filter media depends the inherent tendency of fine particulates to adhere to the filter media as well as the humidity and the “wetness” (i.e, moisture content) of the particulates.

With continued operation, the efficiency of the filter media will diminish. At some in time in the process and as explained below, the flow control panel 256-2 of the flow director valve 256-1 is operated to change or switch the air flow to the other filter compartment 218 (as shown in FIG. 19) to substantially take the filter compartment 216 “off-line”. During the time that the filter compartment 216 is now off-line, the purge valves 238 can be operated to inject one or more pulses or flows of compressed air into the interior of the cartridge filters 230 in the filter compartment 216 to purge the filters 230 (as represented by the downwardly facing arrows in FIG. 17). The purge valves 238 provide a reverse air flow sufficient to “blow-off” any material accumulated on or otherwise “caked-on” the surface of the filter media.

The purge valves 238 are positioned to direct a compressed air blast downwardly though the plenum headspace 232 into respective filters 230. As shown in FIGS. 18 and 19, the individual purge valves 238 are connected to a compressed air line or manifold which, in turn, is pressurized via a compressor 300 with ambient air provided through an intake 302. In the preferred embodiment, the compressor 300 is driven from the auxiliary engine that drives the fan wheel 30 although the compressor 300 can be driven from the vehicle engine.

While the purge valves 238 of FIGS. 18 and 19 are shown as directing the compressed air flow downwardly across the respective headspace, 232 and 234, into the open interiors of the filter elements 230, the use of wands or tubes extending from the purge valves 238 is not excluded.

The timing of the “on-line/off-line” periods as well as the timing and duration of the reverse air pulses can be performed in accordance with the program described above with respect to the structures of FIGS. 1-17.

The system as described above includes compartments that having substantially equal working volumes; as can be appreciated, the filter compartments 232/234, need not be equal in working volume and one of the compartments can be substantially smaller than the other, as shown, for example, in FIG. 20. In FIG. 20, the compartment shown to the right is approximately one-half the working volume of the other; in this case, the respective time durations of the filter/purging times can be appropriately adjusted. If desired, the smaller of the two compartments can have a size such that it will filter the air flow for only the minimal amount of time necessary to purge the filters in the larger of the two compartments.

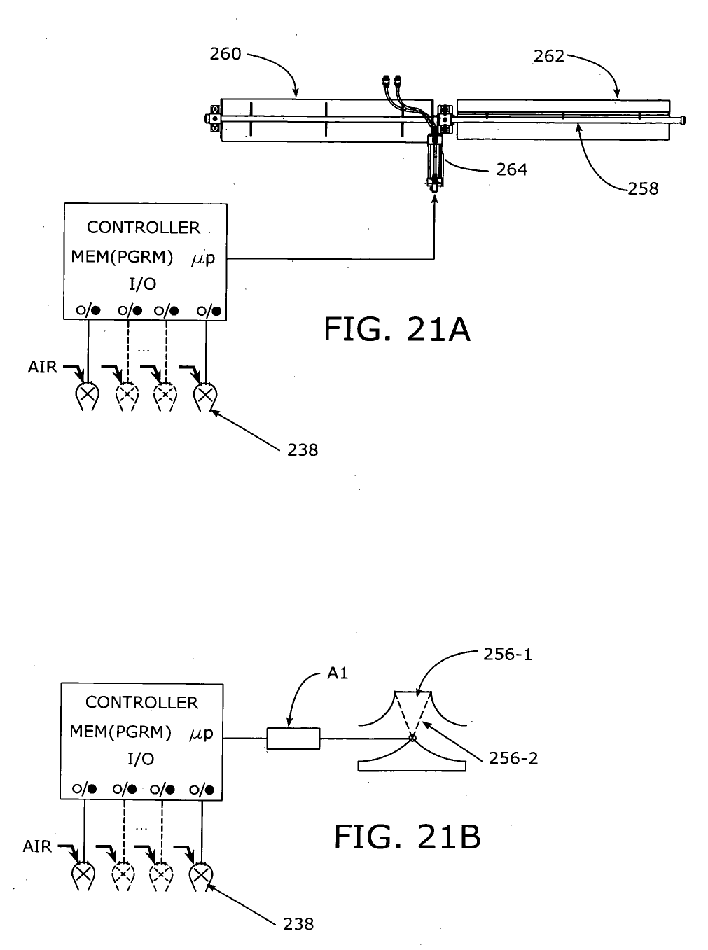

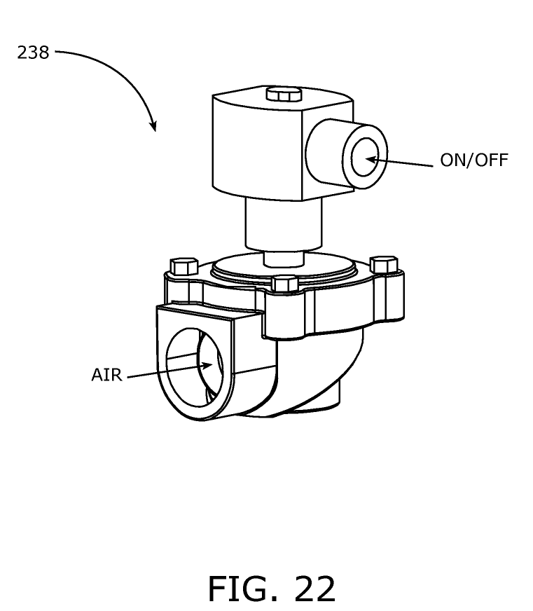

The systems of FIGS. 1-17 and of FIGS. 18-21 can be controlled in accordance with the schematic representations in FIGS. 21a and 21b. As shown in FIG. 21a, a controller is connected electrically to each of the various purge valves 238, which, in turn, are connected to the vehicle air supply line. As indicated by the symbol ∘/, each valve 238 can be opened or closed under the control of the controller to create the desired air blast consistent with the flow diagram of FIG. 15d or some functional equivalent including the multi-row table arrangement described above. Additionally, the controller is also connected to the pneumatic cylinder 264 to control the pneumatic cylinder 264 to rotate the shaft 258 to place one or the other filter compartment on-line and off-line as discussed above.

In addition to the IFM controller disclosed above, the controller can take the form of one or more firmware- or software-controlled microprocessors or microcomputers (as well as special-purpose processors, including RISC processors), application specific integrated circuits (ASIC), programmable logic arrays (PLA), discrete logic or analog circuits, with associated volatile or non-volatile memory and/or combinations thereof.

FIG. 21b is similar to FIG. 21a but illustrates an actuator A1 connected to the flow control panel 256-2 for moving the panel to and from its respective positions. The actuator A1 may take the form of hydraulic, pneumatic, electrical, and/or electromechanical devices, although pneumatic is preferred.

While firmware- or software-controlled microprocessors or microcomputers are preferred for the controller, the controller can also take the form a set of motor-driven rotary cams operating cam-driven switches to turn the various purge valves 238 on and off and, in the case of FIG. 21a, to control the pneumatic cylinder 264 (or an electrical or hydraulic functional equivalent) and, in the case of FIG. 21b, to control the actuator A1.

If desired, the “on-line/off-line” periods can be controlled using pressure sensors S1/S2 to sense the pressure differential across the filter media and provide inputs to the controller to control the on-line/off-line operation of the filter compartments.

As will be apparent to those skilled in the art, various changes and modifications may be made to the illustrated embodiment of the present invention without departing from the spirit and scope of the invention as determined in the appended claims and their legal equivalent.

1. A dust or particulate separation system for a wheeled roadway/pavement cleaning vehicle of the type having an air-flow recirculation loop including a motor-powered fan having an outlet connected to a pick-up hood for passing an air flow through the pick-up hood and into a separation compartment for separating at least some of any particulates entrained in the air flow therefrom, comprising:
first and second filter compartments in flow communication with the separation compartment and each having filter media therein for filtering at least some of any particulates entrained in any air flow from the separation compartment;
a valve means for selectively causing at least a major portion of the air flow from the separation compartment to flow through one or the other of the first and second filter compartments and into an inlet of the fan;
a plurality of purge valves associated with each of the first and second filter compartments for subjecting the filter media therein to an air flow onto the side of the filter media opposite the side thereon having any particulates thereon to dislodge at least some of any particulates thereon therefrom; and
a controller for selectively controlling the valve means and the purge valves associated with each of the first and second filter compartments to control the valve means to cause at least a major portion of the air from the separation compartment to flow through one of the first and second filter compartments and to control the purge valves to subject the filter media of the other of the first and second filter compartments to an air flow to remove at least some of any particulates thereon therefrom.

2. The dust or particulate separation system of claim 1, wherein the filter media in each filter compartment comprises a plurality of cartridge filters.

3. The dust or particulate separation system of claim 2, wherein a purge valve is associated with a cartridge filter for directing an air flow onto the side of the filter media opposite the side thereof having any particulates thereon to dislodge any particulates thereon therefrom.

4. The dust or particulate separation system of claim 1, wherein the first filter compartment includes an opening therein for the passage of filtered air therefrom and the second filter compartment includes an opening therein for the passage of filtered air therefrom, the valve means comprising a first moveably mounted plate for substantially blocking filtered air flow through the opening in the first filter compartment and a second moveably mounted plate for substantially blocking filtered air flow through the opening in the second filter compartment and at least one actuator connected to said first and second moveably mounted plates for moving said plates to substantially block air flow through one or the other of said openings in said first and second filter compartments.

5. The dust or particulate separation system of claim 1, wherein the first filter compartment includes an opening therein for the passage of filtered air therefrom and the second filter compartment includes an opening therein for the passage of filtered air therefrom, the valve means comprising a rotatably mounted shaft carrying a first plate for substantially blocking or allowing filtered air flow through the opening in the first filter compartment and a second plate for substantially blocking or allowing filtered air flow through the opening in the second filter compartment and at least one actuator connected to said shaft for rotating said shaft to a first position in which said first plate substantially blocks air flow through the opening in said first filter compartment and said second plate does not substantially block air flow through the opening in said first filter compartment and a second position in which said second plate substantially blocks air flow through the opening in the second filter compartment said first plate does not substantially block air flow through the opening in said first filter compartment.

6. The dust or particulate separation system of claim 1, wherein the valve means comprises a first duct in air flow communication with the first filter compartment for conducting filtered air from the first filter compartment and a second duct in air flow communication with the second filter compartment for conducting filtered air from the second filter compartment, the first and the second ducts connected to a third duct through which filtered air from either the first duct or the second duct is passed into the inlet of the fan, a moveably mounted panel and an actuator connected to said panel for moving said panel to a first position in which air flow through said first duct is substantially blocked to pass filtered air from the second filter compartment through the third duct and a second position in which air flow through said second duct is substantially blocked to pass filtered air from the first filter compartment through the third duct.

7. The dust or particulate separation system of claim 5, wherein the controller comprises a stored-program controlled processor for controlling the at least one actuator to substantially block filtered air flow through opening in the first filter compartment and for controlling the purge valves associated with the first filter compartment to direct an air flow onto the filter media in the first filter compartment on the side thereof opposite the side having any particulates thereon to dislodge at least some of any particulates thereon therefrom and thereafter controlling the actuator to substantially block filtered air flow through the opening in the second filter compartment and for controlling the purge valves associated with the second filter compartment to direct an air flow onto the filter media in the second filter compartment on the side thereof opposite the side having any particulates thereon to dislodge at least some of any particulates thereon therefrom.

8. The dust or particulate separation system of claim 6, wherein the controller comprises a stored-program controlled processor for controlling the actuator to control the movably mounted panel to substantially block filtered air flow through the first duct and for controlling the purge valves associated with the first filter compartment to direct an air flow onto the filter media in the first filter compartment on the side thereof opposite the side having any particulates thereon to dislodge at least some of any particulates thereon therefrom and thereafter controlling the at least one actuator to control the movably mounted panel to substantially block filtered air flow through the second duct and for controlling the purge valves associated with the second filter compartment to direct an air flow onto the filter media in the second filter compartment on the side thereof opposite the side having any particulates thereon to dislodge at least some of any particulates thereon therefrom.

9. A dust or particulate separation system for a wheeled roadway/pavement cleaning vehicle of the type having an air-flow recirculation loop including a motor-powered fan having an outlet connected to a pick-up hood for passing an air flow through the pick-up hood and into a separation compartment for separating at least some of any particulates entrained in the air flow therefrom, comprising:
a first filter compartment in flow communication with the separation compartment and having filter media therein for filtering at least some of any particulates entrained in any air flow from the separation compartment;
a second filter compartment in flow communication with the separation compartment and having filter media therein for filtering at least some of any particulates entrained in any air flow from the separation compartment;
a valve means for selectively causing at least a major portion of any air flow from the separation compartment to flow through one or the other of the first and second filter compartments and into an inlet of the fan;
a first plurality of purge valves associated with the first compartment for subjecting the filter media therein to a reverse air flow therethrough to remove at least some of any particulates thereon therefrom;
a second plurality of purge valves associated with the first compartment for subjecting the filter media therein to a reverse air flow therethrough to remove at least some of any particulates thereon therefrom; and
a controller for selectively controlling the valve means and the purge valves associated with each of the first and second filter compartments to control the valve means to cause at least a major portion of the air flow from the separation compartment to flow through the first filter compartment to filter at least some of any particulates entrained in any air flow from the separation compartment therefrom and to control the purge valves to subject the filter media of the second filter compartment to a reverse air flow to remove at least some of any particulates thereon therefrom and to thereafter control the valve means to cause at least a major portion of the air flow from the separation compartment to flow through the second filter compartment to filter at least some of any particulates entrained in any air flow from the separation compartment therefrom and to control the purge valves to subject the filter media of the first filter compartment to a reverse air flow to remove at least some of any particulates thereon therefrom.

10. The dust or particulate separation system of claim 9, wherein the filter media in each filter compartment comprises a plurality of cartridge filters.

11. The dust or particulate separation system of claim 10, wherein a purge valve is associated with a cartridge filter for directing an air flow onto the side of the filter media opposite the side thereof having any particulates thereon to dislodge any particulates thereon therefrom.

12. The dust or particulate separation system of claim 9, wherein the first filter compartment includes an opening therein for the passage of filtered air therefrom and the second filter compartment includes an opening therein for the passage of filtered air therefrom, the valve means comprising a first moveably mounted plate for substantially blocking filtered air flow through the opening in the first filter compartment and a second moveably mounted plate for substantially blocking filtered air flow through the opening in the second filter compartment and an actuator connected to said first and second moveably mounted plates for moving said plates to substantially block air flow through one or the other of said openings in said first and second filter compartments.

13. The dust or particulate separation system of claim 9, wherein the first filter compartment includes an opening therein for the passage of filtered air therefrom and the second filter compartment includes an opening therein for the passage of filtered air therefrom, the valve means comprising a rotatably mounted shaft carrying a first plate for substantially blocking or allowing filtered air flow through the opening in the first filter compartment and a second plate for substantially blocking or allowing filtered air flow through the opening in the second filter compartment and an actuator connected to said shaft for rotating said shaft to a first position in which said first plate substantially blocks air flow through the opening in said first filter compartment and said second plate does not substantially block air flow through the opening in said first filter compartment and a second position in which said second plate substantially blocks air flow through the opening in the second filter compartment said first plate does not substantially block air flow through the opening in said first filter compartment.

14. The dust or particulate separation system of claim 9, wherein the valve means comprises a first duct in air flow communication with the first filter compartment for conducting filtered air from the first filter compartment and a second duct in air flow communication with the second filter compartment for conducting filtered air from the second filter compartment, the first and the second ducts connected to a third duct through which filtered air from either the first duct or the second duct is passed into the inlet of the fan, a moveably mounted panel and an actuator connected to said panel for moving said panel to a first position in which air flow through said first duct is substantially blocked to pass filtered air from the second filter compartment through the third duct and a second position in which air flow through said second duct is substantially blocked to pass filtered air from the first filter compartment through the third duct.

15. The dust or particulate separation system of claim 5, wherein the controller comprises a stored-program controlled processor for controlling the actuator to substantially block filtered air flow through opening in the first filter compartment and for controlling the purge valves associated with the first filter compartment to direct an air flow onto the filter media in the first filter compartment on the side thereof opposite the side having any particulates thereon to dislodge at least some of any particulates thereon therefrom and thereafter controlling the actuator to substantially block filtered air flow through the opening in the second filter compartment and for controlling the purge valves associated with the second filter compartment to direct an air flow onto the filter media in the second filter compartment on the side thereof opposite the side having any particulates thereon to dislodge at least some of any particulates thereon therefrom.

16. The dust or particulate separation system of claim 6, wherein the controller comprises a stored-program controlled processor for controlling the actuator to control the movably mounted panel to substantially block filtered air flow through the first duct and for controlling the purge valves associated with the first filter compartment to direct an air flow onto the filter media in the first filter compartment on the side thereof opposite the side having any particulates thereon to dislodge at least some of any particulates thereon therefrom and thereafter controlling the actuator to control the movably mounted panel to substantially block filtered air flow through the second duct and for controlling the purge valves associated with the second filter compartment to direct an air flow onto the filter media in the second filter compartment on the side thereof opposite the side having any particulates thereon to dislodge at least some of any particulates thereon therefrom.

17. A dust or particulate separation system for a wheeled roadway/pavement cleaning vehicle of the type having an air-flow recirculation loop including a motor-powered fan having an outlet connected to a pick-up hood for passing an air flow through the pick-up hood and into a separation compartment for separating at least some of any particulates entrained in the air flow therefrom, comprising:
a first filter compartment in air flow communication with the separation compartment and having a plurality of filter cartridges therein for filtering at least some of any particulates entrained in any air flow from the separation compartment;
a second filter compartment in air flow communication with the separation compartment and having a plurality of filter cartridges therein for filtering at least some of any particulates entrained in any air flow from the separation compartment;
an air flow control arrangement for selectively causing at least a major portion of any air flow from the separation compartment to flow through one or the other of the first and second filter compartments and into an inlet of the fan;
a selectively controlled actuator connected to the air flow control arrangement for controlling the air flow control arrangement to cause at least a major portion of any air flow from the separation compartment to flow through one or the other of the first and second filter compartments and into an inlet of the fan
a first plurality of purge valves associated with the first compartment for subjecting each filter cartridge therein to a time-limited air flow therethrough in an air flow direction opposite to the direction of the air flow from the separation compartment to remove at least some of any particulates thereon therefrom;
a second plurality of purge valves associated with the second compartment for subjecting each filter cartridge therein to a time-limited air flow therethrough in an air flow direction opposite to the direction of the air flow from the separation compartment to remove at least some of any particulates thereon therefrom; and
a stored-program controlled processor for selectively controlling the actuator and the purge valves associated with each of the first and second filter compartments to control the air flow control arrangement to cause at least a major portion of any air flow from the separation compartment to flow through the first filter compartment to filter at least some of any particulates entrained in any air flow from the separation compartment therefrom and to control the purge valves of the second filter compartment to subject the filter cartridges of the second filter compartment to a time-limited air flow therethrough in an air flow direction opposite to the direction of the air flow from the separation compartment to remove at least some of any particulates thereon therefrom and to thereafter control the air flow control arrangement to cause at least a major portion of any air flow from the separation compartment to flow through the second filter compartment to filter at least some of any particulates entrained in any air flow from the separation compartment therefrom and to control the purge valves of the first filter compartment to subject the filter cartridges of the first filter compartment to a time-limited air flow therethrough in an air flow direction opposite to the direction of the air flow from the separation compartment to remove at least some of any particulates thereon therefrom.

18. The dust or particulate separation system of claim 17, wherein said first filter compartment has an opening therein for air flow communication with the inlet of the fan and said second filter compartments has an opening therein for air flow communication with the inlet of the fan, the air flow control arrangement including a first movable panel for selectively blocking said opening of said first filter compartment and a second movable panel for selectively blocking said opening of said second filter compartment and an actuator means connected to said first and second movable panels for controlling the movement thereof relative to said openings.

19. The dust or particulate separation system of claim 17, wherein said air flow control arrangement comprises a first duct for air flow communication between the first filter compartment and the inlet of the fan, a second duct for air flow communication between the second filter compartment and the inlet of the fan and a third duct connected between said first and second ducts and the inlet of the fan, a moveable panel moveable between a first position in which a major portion of the air flow in the first filter chamber is directed to the third duct and a second position in which a major portion of the air flow in the second filter compartment is directed to the third duct.
